(19) United States
(12) Patent Application Publication
(10) Pub. No.: US 2026/0210912 A1
(43) Pub. Date: Jul. 23, 2026

(54) PHOTOACOUSTIC DEVICES AND METHODS OF MANUFACTURE THEREOF

(71) Applicant: University of Massachusetts, Boston, MA (US)

(72) Inventors: Xingwei Wang, Shrewsbury, MA (US); Andres Miguel Biondi Vaccariello, Lowell, MA (US); Rui Wu, Lowell, MA (US)

(21) Appl. No.: 19/140,050

(22) PCT Filed: Dec. 26, 2023
(86) PCT No.: PCT/US2023/085900

§ 371 Date: Jun. 17, 2025

Related U.S. Application Data
(60) Provisional application No. 63/477,019, filed on Dec. 23, 2022.

(51) Int. Cl. G01N 29/24; G02F 1/125

(52) U.S. Cl. CPC G01N 29/2418; G02F 1/125

(57) ABSTRACT

Disclosed herein is an emitter for a sensor, the emitter comprising a source of visible light; an optical waveguide in optical communication with the source of light; and an optical absorption film in optical communication with the optical waveguide; where the optical absorption film has a different coefficient of thermal expansion from the optical waveguide; where the optical absorption film contacts a) a circumferential core surface of the optical waveguide; b) does not physically contact the optical waveguide but is located downstream of the optical waveguide; or c) is located on the circumferential core surface of the optical waveguide and downstream of the optical waveguide.

### CROSS-REFERENCE TO RELATED APPLICATIONS

This disclosure claims priority to U.S. Provisional Application No. 63/477,019, filed on Dec. 23, 2022, the entire contents of which are incorporated herein in their entirety.

### BACKGROUND

This disclosure relates to photoacoustic devices and to methods of manufacture thereof. In particular, this disclosure relates to photoacoustic devices, and more specifically to improved photoacoustic transmitters, receivers, and methods of manufacture thereof.

### SUMMARY

Disclosed herein is an emitter for a sensor, the emitter comprising a source of visible light; an optical waveguide in optical communication with the source of light; and an optical absorption film in optical communication with the optical waveguide; where the optical absorption film has a different coefficient of thermal expansion from the optical waveguide; where the optical absorption film contacts a) a circumferential core surface of the optical waveguide; b) does not physically contact the optical waveguide but is located downstream of the optical waveguide; or c) is located on the circumferential core surface of the optical waveguide and downstream of the optical waveguide.

Disclosed herein is a receiver for a sensor, the receiver comprising an optical having a distal end and a proximal end; and a diaphragm disposed apart from the distal end of the optical waveguide; where a cavity located between the distal end and the diaphragm functions as a Fabry-Perot cavity; where the proximal end of the optical waveguide is in optical communication with a photodiode, an avalanche photodiode, a phototransistor, or a combination thereof.

Disclosed herein is a sensor comprising an emitter and a receiver; where the emitter comprises a source of visible light; a first optical waveguide in optical communication with the source of light; and an optical absorption film in optical communication with the first optical waveguide; where the optical absorption film has a different coefficient of thermal expansion from the first optical waveguide; where the optical absorption film contacts a) a circumferential core surface of the first optical waveguide; b) a distal end of the first optical waveguide and is located downstream of the optical waveguide; or c) is located on the circumferential core surface of the first optical waveguide and downstream of the first optical waveguide at the distal end of the first optical waveguide; and where the receiver comprises a second optical waveguide having a distal end and a proximal end; and a diaphragm disposed apart from the distal end of the second optical waveguide; where a cavity located between the distal end and the diaphragm functions as a Fabry-Perot cavity; where the proximal end of the second optical waveguide is in optical communication with a photodiode, an avalanche photodiode, a phototransistor, or a combination thereof; where the first optical waveguide circumscribes the second optical waveguide; where the second optical waveguide is a single mode optical waveguide.

Disclosed herein is a method of determining a property of a media, the method comprising disposing a sensor in a vessel that contains a media; where the sensor comprises an emitter; transmitting an incident light signal from a visible source of light to the emitter via a first optical waveguide; promoting an acoustic vibration in the emitter in response to light absorbed from the incident light signal; where the acoustic vibration is in the ultrasonic regime; disposing a receiver in the vessel; where the receiver comprises a Fabry Perot cavity in optical communication with a second optical waveguide; receiving a reflected acoustic signal from the media in response to the incident light signal; creating a standing acoustic wave in a Fabry Perot cavity; modulating an optical standing wave in the second optical waveguide with the standing acoustic wave; where the standing acoustic wave induces a periodic modulation in a refractive index of the second optical waveguide; and determining a property of the media, by the amount of modulation of the refractive index of the second optical waveguide.

### BRIEF DESCRIPTION OF THE FIGURES

FIG. 1 depicts one embodiment of an exemplary emitter where the film is disposed on a circumferential outer surface of an optical fiber or an optical waveguide that is in optical communication with a light source;

FIG. 2 depicts another embodiment of an exemplary emitter where the emitter has a plurality of films disposed on an outer circumferential surface of the optical fiber (or the optical waveguide);

FIG. 3A depicts an optical fiber with a tapered region that has a reduced diameter compared with the rest of the fiber;

FIG. 3B depicts the emitter with the film disposed on the optical fiber of FIG. 3A;

FIG. 4A depicts a sectional side view of a film having a partially conical shape that circumscribes the optical fiber without contacting it;

FIG. 4B depicts a sectional side view of a film that lies across an end of the optical fiber without contacting it. A lens is disposed between the film and an end of the optical fiber;

FIG. 4C depicts yet another embodiment of a sectional side view of a film that lies across from an end of the optical fiber without contacting it. A reflective mirror reflects light from the optical fiber onto the film;

FIG. 5A depicts a housing in contact with the film (thus functioning as an emitter), a receiver and a gas sensor;

FIG. 5B depicts a housing in the shape of a flower that supports a film (the emitter), a temperature sensor and a pressure sensor;

FIG. 6 depicts one embodiment of an exemplary receiver;

FIGS. 7-9 depict other embodiments of exemplary receiver designs;

FIGS. 10A-10C depict exemplary embodiments of a combined emitter and receiver sensor;

FIGS. 11A-11C depict exemplary embodiments of a combined emitter and receiver sensor;

FIGS. 12A and 12B are graphs which measure acoustic pressure (MPa) versus radius for the resin used as an acoustic emitter;

FIG. 13 is a graph of pressure versus time in microseconds for the 1500 μm fiber tip;

FIG. 14 is a graph of pressure versus time in microseconds as the hydrophone is moved away from the 1500 μm fiber tip;

FIG. 15 shows a schematic of the experiment setup used in Example 3; and

FIG. 16 is a graph that depicts the ultrasound signal detected from each emitter when the emitter is located in a water tank.

### DETAILED DESCRIPTION

### Definitions

A solid core optical waveguide is one where the core, which is the central part through which light travels, is made of a solid material. The surrounding layer, called the cladding, has a lower refractive index than the core, allowing the waveguide to guide light through total internal reflection. The term “waveguide” includes optical waveguides. Optical waveguides may have different dimensions depending on the wavelength, refractive index of different layers, the length, width, depth, or the like. The term “waveguide” is inclusive of a fiber such as an optical fiber.

A hollow optical waveguide, also known as a photonic bandgap waveguide or micro-structured optical fiber, is an optical waveguide with a unique structure that includes a hollow core surrounded by a periodic arrangement of air holes or other materials.

A photonic crystal fiber (PCF), also known as a microstructured or a holey fiber, is a type of optical waveguide that incorporates a periodic arrangement of airholes or voids running along the length of the waveguide.

A Long Period Grating (LPG) is a type of optical waveguide device that induces periodic variations in the refractive index along the length of an optical waveguide. Long period gratings comprise a series of refractive index perturbations (typically created by periodic variations in the core diameter or the refractive index of the cladding) over a relatively long section of the optical waveguide, typically several millimeters to centimeters. They are effective for coupling light between the core and the cladding modes of the optical waveguide.

A “Bragg grating” in the context of optical waveguides refers to a waveguide grating with a shorter grating period compared to a typical long-period grating (LPG), typically in the range of few micrometers. The are used to create a wavelength specific reflection and allows them to have higher selectivity and narrower bandwidth.

Single mode waveguide is an optical waveguide that allows only one mode of light to propagate through the waveguide. Single mode waveguides have a very small core diameter (around 7 to 9 micrometers) and allow only one mode of light to propagate in a 125 micrometer waveguide.

Multi-mode waveguides have many different designs, including those with a larger core diameter (typically 50 or 62.5 micrometers) and support multiple modes of light propagation.

Disclosed herein is a sensor that comprises an emitter and a receiver both of which contain an optical fiber/waveguide. The sensor can convert light into acoustic energy and vice versa. In the emitter, light from a light source is transmitted to an optical absorbing film (hereinafter film), which absorbs some of the light and converts it into pressure waves (acoustic energy or acoustic waves). The acoustic energy can then be transmitted into a medium whose properties are to be determined. A reflected acoustic signal from the medium can be picked up by the receiver. The receiver converts the reflected acoustic signal into a corresponding light signal via a Fabry-Perot interferometer and transmits this corresponding light signal back to a device that measures the desired properties. The device that measures the corresponding light signal may be the same as the device that contains the light source. In other words, the light source and the device that measures the corresponding light signal may be integrated into a single piece of equipment. The sensor can be used to measure temperature, stiffness, porosity, and other properties of the medium.

In an embodiment, a portion of the emitter and the receiver are manufactured by additive manufacturing (also called 3D manufacturing) and then fitted onto an optical fiber/waveguide using an adhesive.

### The Emitter

The emitter for a sensor comprises a source of visible light, an optical waveguide in optical communication with the source of light and an optical absorption film in optical communication with the optical waveguide. The optical absorption film has a different coefficient of thermal expansion from the optical waveguide. In an embodiment, the optical absorption film contacts a) a circumferential core surface of the optical waveguide; b) does not physically contact the optical waveguide but is located downstream of the optical waveguide; or c) is located on the circumferential core surface of the optical waveguide and downstream of the optical waveguide but is not in contact with the optical waveguide.

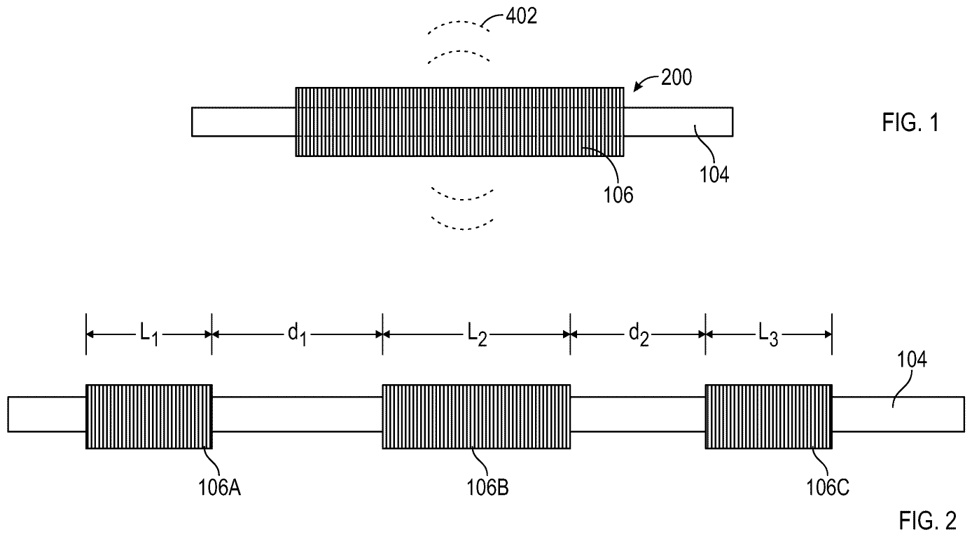

The emitter generally comprises one or more optically absorbing films (hereinafter film) that is/are disposed on a circumferential surface of the optical waveguide or on a surface located outside of the optical waveguide and across from an end of the optical waveguide. FIG. 1 depicts one embodiment of an exemplary emitter 200 where the film 106 is disposed on a circumferential outer surface of an optical waveguide 104 that is in optical communication with a light source (not shown). The circumferential surface or circumferential outer surface referred to herein is the circumferential surface of the core of the optical waveguide. The film 106 is directly in contact with a circumferential surface of the core of the solid optical waveguide after the cladding and buffer is removed. In an embodiment, the light source may be a laser that introduces light into the optical waveguide. The film absorbs some of the light and converts it into incident pressure waves (hereinafter “acoustic waves”) 402. The acoustic waves 402 can then be transmitted into a medium whose properties are to be determined. Reflected acoustic waves (not shown in FIG. 1) are collected by the receiver and analyzed to provide a measure of the properties that are sought.

The film 106 comprises an elastomer in which an optically absorbing material (hereinafter “optical absorber”) is dispersed. The different types of elastomers and optical absorbers that may be used are described in detail later. The film 106 has a higher coefficient of thermal expansion than the optical waveguide 104 upon which it is disposed. It contacts the optical waveguide 104 directly in a region from which the optical waveguide cladding is removed. It absorbs light being transmitted along the optical waveguide and heats up thereby promoting an expansion. The light is absorbed primarily by the optical absorber, which heats up the surrounding elastomer and promotes its expansion. The expansion results in the generation of acoustic waves 402 which can be transmitted to the media that the emitter is in contact with.

The optical waveguide 104 can be a solid-core optical waveguide, a hollow optical waveguide, a photonic crystal waveguide, or a waveguide such as, for example silicon on a chip. The optical waveguide can operate as a single mode cavity or a multimode cavity. The various optical fibers and waveguides disclosed above can be endowed with or be devoid of a long-period grating or a short-period grating.

FIG. 2 depicts another embodiment of an exemplary emitter 200 where the emitter has a plurality of films 106A, 106B, 106C, . . . , 106n, where “n” is an integer from 1 to 100, and where each film 106A, 106B, 106C, . . . , 106n can generate acoustic waves independently of the other films. In an embodiment, “n” can be greater than 2, greater than 3, greater than 5, greater than 10, up to an amount of 100. Each film 106A, 106B, 106C, . . . , 106n is concentrically located with the circumference of the optical waveguide 104. The inner surface and outer surface of each film are parallel with each other and the thickness of the film is constant. Each film may generate acoustic waves at the same frequency or alternatively, each film may generate an acoustic wave having a different frequency λ_{A}, λ_{B}, λ_{C}, λ_{D}, . . . λₙ from each other. The intensity of the acoustic waves generated from at least one film could be different from those of the other films. In an embodiment, the intensity of the acoustic wave generated by each film may be different from that of the other films.

In an embodiment, the films 106A, 106B, 106C, . . . , 106n can have the same or different lengths “1”. In one embodiment, each film can have a different length. For example, as seen in the FIG. 2, the length “L₁” of 106A can be equal to the length “L₃” of 106C, while the lengths of 106A and 106C can both be smaller than the length “L₂” of 106B. In an embodiment, the length of each film L₁, L₂, L₃, and so on, can vary in an amount of 2 to 50 millimeters, 5 to 20 millimeters and 10 to 15 millimeters.

In an embodiment, the films 106A, 106B, 106C, . . . , 106n can have the same or different thicknesses “t”. In one embodiment, each film can have a different thickness. The thickness of the different films can vary in an amount of 30 to 90 micrometers, 40 to 80 micrometers and 30 to 70 micrometers.

The distance between successive films 106A, 106B, 106C, . . . , 106n can be periodic or aperiodic. The distance between successive films on the optical waveguide may be 20 to 300 millimeters, preferably 30 to 200 millimeters, and more preferably 50 to 150 millimeters.

In an embodiment, each film 106A, 106B, 106C, . . . , 106n can have the same or a different composition. In an exemplary embodiment, at least one film of the plurality of films has a different composition from the remaining films present in the emitter. In another embodiment, each film has a different composition from one another.

Films absorb light of different wavelengths depending upon their compositions. Films having a first composition (e.g., 106A) may therefore absorb light of different wavelengths from films having a second composition (e.g., 106B). The acoustic wavelengths emitted by the different films will also be different. An emitter that comprises several different films may therefore be used to measure a variety of different properties of a structure or material in which it is place.

Thus, by choosing a different material for each film 106A, 106B, 106C, . . . , 106n a specific wavelength of the incident light and the launching time of light into the waveguide may be used to enable different emitters to produce acoustic waves of different wavelengths and intensities (in the ultrasound regime). In another embodiment, light of different wavelengths may be emitted into the optical waveguide to be absorbed by different films 106A, 106B, 106C, . . . , 106n based on the composition and dimensions of the film. The different wavelengths absorbed by the different films will result in the emission of acoustic waves of different wavelengths and different intensities.

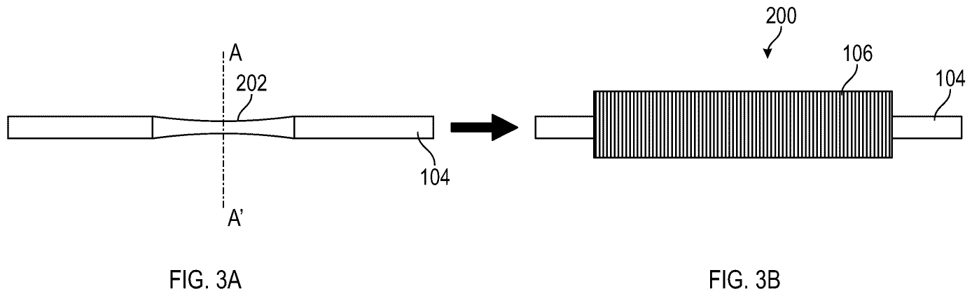

FIGS. 3A and 3B depict emitters, where the film 106 is disposed on a tapered region 202 of the optical waveguide 104 that has a reduced diameter. The tapered region 202 refers to the core of the optical waveguide (with cladding and buffer removed) that has a narrower diameter than the remainder of the core of the optical waveguide. FIG. 3A depicts an optical waveguide 106 with a tapered region 202 that has a reduced diameter core as compared with the core for the rest of the waveguide. FIG. 3B depicts the emitter 200 with the film 106 disposed on the optical waveguide of FIG. 3A. The tapered region is generally symmetrical along the length of the waveguide and in a direction perpendicular to the length of the waveguide (along axis AA′). The cross-sectional diameter (and hence area) in the center of the tapered region is reduced compared with the cross-sectional diameter and area of the optical waveguide outside the tapered region. The reduced cross-sectional diameter of the tapered region is produced by removing the cladding from a portion of the optical waveguide (to produce an exposed region) and then heating the waveguide (to an elevated temperature) under a tensile drawing force. The optical waveguide is subjected to a tensile pressure greater than the yield strength (in the exposed region) thus producing necking, which causes the reduced cross-sectional diameter. A film 106 is then disposed on the optical waveguide 104 to cover the tapered surface. The film 106 contacts the tapered surface directly. The film 106 is concentrically located about the outer surface of the optical waveguide 104.

Tapering the waveguide offers numerous advantages for enhancing the coupling efficiency of light into the film disposed on the waveguide. By carefully reducing the waveguide s diameter along its length, a controlled leakage of light from the waveguide core to the film is enabled thus promoting efficient interaction between the light and the optically absorbing material. This improved coupling enables more effective photoacoustic signal generation and detection, making it a valuable technique for various sensing and imaging applications in areas such as medical diagnostics and materials characterization. This process can improve the generated ultrasound signal power.

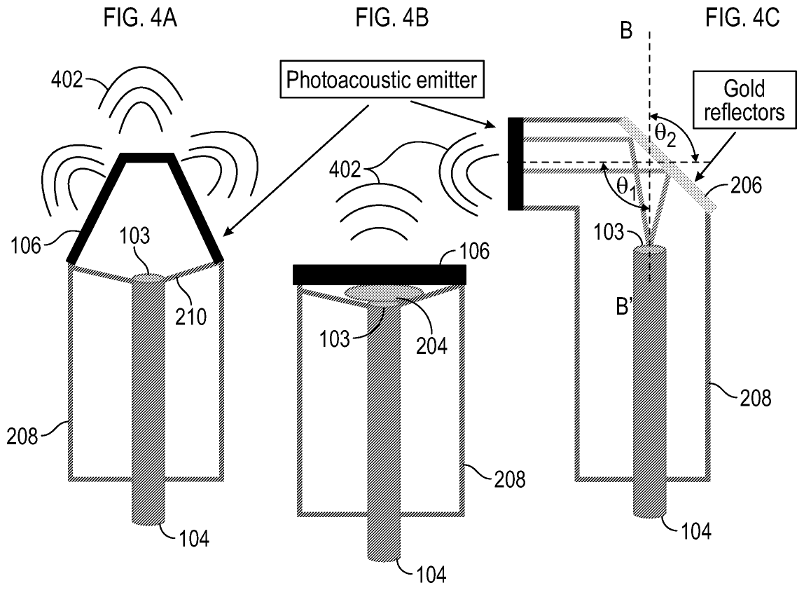

In an embodiment, the film 106 used in the emitter may have different shapes or geometries. The film 106 may be located outside the optical waveguide 104 (i.e., it does not physically contact the optical waveguide along an entire surface of the film). The film 106 is located downstream of the optical waveguide 104. FIGS. 4A-4C depict a number of different geometries that the film 106 can be formed into. These figures also depict the different emitter configurations. Each configuration comprises a housing 208 with an optical waveguide 104 disposed therein. The housing 208 is an enclosure that is used to locate the optical waveguide 104 and to prevent it from being displaced during its use. The housing 208 may also serve as a fixture for locating the film 106 and retaining it in position. In an embodiment, the housing 208 secures the optical waveguide 104 in a position so that light emitted by the optical waveguide may be directed to the film 106 without any obstruction or interference. The housing 208 prevents external light (ambient light) from entering it and interfering with the light from the optical waveguide that is incident on an inner surface of the film 106. Disposed across an end 103 of the optical waveguide 104 (and downstream of the optical waveguide 104) is the film 106 that converts light received from the optical waveguide into an acoustic wave 402.

FIG. 4A depicts a sectional side view of a film 106 having a partially conical shape that circumscribes the optical waveguide 104 without contacting it. The film can have a cross-sectional side view that is triangular, square, rectangular, polygonal (e.g., pentagonal, hexagonal, and so on). In order for the film (which is elastomeric) to take these different desired shapes, the film may be mounted on a porous scaffold (not shown). The film can therefore have multiple outer surfaces, each of which is oriented in different directions. The film can also have one or more corners, two or more corners, three or more corners, and so on. The porous scaffold has the desired shape and is transparent to optical light. A porous optical scaffold may be manufactured from quartz, polyester, polystyrene, polymethylmethacrylate, or a combination thereof. Light transmitted through the optical waveguide is incident upon the film through the scaffold causing the film to heat and vibrate (producing acoustic waves) as detailed above.

FIG. 4B depicts a sectional side view of a film 106 that lies across an end 103 of the optical waveguide 104 without contacting it. A lens 204 is disposed between the optical waveguide 104 and the film 106. One surface of the lens 204 may contact an end 103 of the optical waveguide with an opposing surface contacting the film 106. In another embodiment, the lens 204 may be spaced apart from the optical waveguide 104 as well as the film 106. In other words, the lens does not contact either the optical waveguide or the film but is disposed between them. Light transmitted through the optical waveguide is incident upon the film through the lens 204 causing the film to heat and vibrate (producing acoustic waves).

FIG. 4C depicts yet another embodiment of a sectional side view of a film 106 that lies across from an end 103 of the optical waveguide 104 without contacting it. In this particular case, the film 106 is located at an angle θ1 to a longitudinal axis BB′ of the optical waveguide 104 and receives light via a reflective mirror 206. The mirror 206 may be inclined at an angle θ2 to a longitudinal axis BB′ of the optical waveguide 104. Both θ1 and θ2 can be varied from 5 degrees to 175 degrees. In a preferred embodiment, θ1 can be varied from 80 to 100 degrees.

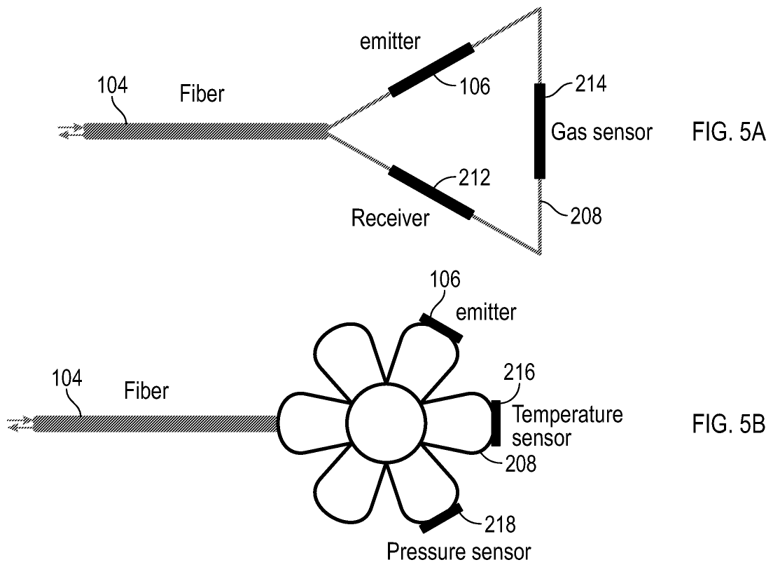

FIGS. 5A and 5B depicts frames 208 that have different shapes. As noted above, the housing 208 serves to prevent external light from interfering with light incident upon the film 106. The housing may have a regular shape defined by Euclidean geometry (e.g., triangular shape) or an irregular shape which is a combination of linear and curvilinear surfaces (e.g., a flower). The irregular shape may include a non-Euclidean geometry. The more surfaces that the housing has, the more sensors it can carry. For example, in FIG. 5A, the housing 208 is in contact with the film 106 (forming an emitter), a receiver 212 (to be described in detail below) and a gas sensor 214.

FIG. 5B depicts a housing 208 in the shape of a flower that supports a film 106 (the emitter), a temperature sensor 216 and a pressure sensor 218. The use of the film on the circumferential surface of the optical waveguide results in a sidewall photoacoustic emitter that can be combined with all kinds of waveguide sensors, such as a pressure sensor based on a Fabry Perot cavity (which is described below), a temperature sensor, a reflex index sensor, a gas sensor, and so on. This design not only provides for multiple parameter measurements at various locations, but the ability to generate and collect multiple forms of data by such a sensor can be used to better understand complex scenarios encountered in life. For example, the combination of various forms of emitters and receivers can be used to detect and localize gas leaks in a pipeline. The optimal design of the combination of a temperature sensor, a strain sensor, a shape sensor, a refractive index sensor can be useful for biomedical applications.

Combinations of the aforementioned embodiments (for the emitter) may be used. For example, the optical waveguide may be disposed on a circumferential surface of the optical waveguide (the optical core) as well as downstream from the end of the optical waveguide (where it does not contact the waveguide). One or more films may be disposed on the circumferential surface of the optical waveguide as detailed above, while one or more films may be disposed downstream from the end of the optical waveguide.

### The Film 106 for the Emitter

The film 106 used in the emitter of FIGS. 1-5B will now be described. Each film comprises an elastomer in which an optical absorber is dispersed. The optical absorber absorbs light energy that is being transported through the optical waveguide. The absorption of light promotes heating in the optical absorber. The heat causes the elastomer to undergo periodic expansion and contraction to generate pressure waves (also known as acoustic waves) in the ultrasonic regime. Ultrasound is sound with frequencies greater than 20 kilohertz. Ultrasonic devices operate with frequencies from 20 kHz up to several gigahertz.

The film 106 comprises an elastic composite that comprises an elastomer and light absorbing particles. As noted above, the film 106 has a different coefficient of thermal expansion from that of the single mode optical waveguide. In an embodiment, the film 106 has a higher coefficient of thermal expansion from that of the single mode optical waveguide. The light absorbing particles are present in an amount effective to absorb visible light and to heat the surrounding elastomer.

The elastomer generally forms the matrix of the film 106 and forms the continuous phase of the material used in the film 106. Elastomers are a class of polymers characterized by their ability to undergo large reversible deformations when subjected to stress and then return to their original shape when the stress is removed. The elastomer may be a naturally occurring elastomer or a synthetic elastomer. The elastomer can be a crosslinked elastomer (e.g., it can contain covalent bonds that facilitate crosslinking), a semicrystalline elastomer (where the crystals facilitate physical entrapment of the polymer chains), an ionomer (where ionic bonds facilitate the crosslinking), or a combination thereof.

The coefficient of thermal expansion for the elastomer is typically about 50×10⁻⁶/° C. to 800×10⁻⁶/° C., preferably 100×10⁻⁶/° C. to 400×10⁻⁶/° C. The elastomer generally has an elastic modulus measured as per ASTM D 638 of 0.1 to 30 megapascals (MPa), preferably 0.5 to 20 MPa at room temperature (around 23° C.).

Examples of elastomers include polybutadienes, polyisoprenes, styrene-butadiene rubber, poly(styrene)-block-poly(butadiene), poly(acrylonitrile)-block-poly(styrene)-block-poly(butadiene) (ABS), polychloroprenes, epichlorohydrin rubber, polyacrylic rubber, silicone elastomers (polysiloxanes), fluorosilicone elastomers, fluoroelastomers, perfluoroelastomers, polyether block amides (PEBA), chlorosulfonated polyethylene, ethylene propylene diene rubber (EPR), ethylene-vinyl acetate elastomers, polyurethanes, or the like, or a combination thereof. A preferred elastomer includes a silicone elastomer. A preferred silicone elastomer is polydimethylsiloxane. Crosslinked polydimethylsiloxane is also preferred as the elastomer.

Other thermoplastic polymers or thermosetting polymers that are not elastomers (at room temperature) may also be used if desired. These thermoplastic polymers and thermosetting polymers may have glass transition temperatures that are greater than room temperature and therefore display elastomeric properties at temperatures greater than room temperature. When the emitter is to be used at an elevated temperature (e.g., greater than 100° C.) then these thermoplastic polymers or thermosetting polymers (which at room temperature are normally below their respective glass transition temperatures) may be used. These thermoplastic polymers and thermosetting polymers are listed below (in reference to the “diaphragm”).

The elastomer is generally present in the film in an amount of 35 to 95 weight percent (wt %), based on a total weight of the film. In a preferred embodiment, the elastomer is generally present in the film in an amount of 50 to 90 weight percent (wt %), based on a total weight of the film.

The light absorbing particles include particles that are capable of absorbing as much light as possible in the visible regime of the electromagnetic spectrum. Materials that are capable of absorbing the most visible light are generally those with pigments or compounds that have strong absorption films within the visible spectrum. The absorption of light by a material depends on its electronic structure and the energy levels of its electrons. The visible spectrum ranges from approximately 380 to 750 nanometers, corresponding to violet to red light.

Examples of light absorbing materials include carbon black; carbon nanotubes; black iron oxide (magnetite); organic dyes ((e.g., polyazaindacenes and/or coumarins, lanthanide complexes, hydrocarbon and substituted hydrocarbon dyes, polycyclic aromatic hydrocarbons); scintillation dyes (e.g., oxazoles and oxadiazoles); aryl- and heteroaryl-substituted polyolefins (C₂-C₈ olefin portion); carbocyanine dyes, perylene dyes and pigments, phthalocyanine dyes and pigments; oxazine dyes, carbostyryl dyes, porphyrin dyes, acridine dyes, anthraquinone dyes, anthrapyridone dyes, naphtalimide dyes, benzimidazole derivatives, arylmethane dyes, azo dyes, diazonium dyes, nitro dyes, quinone imine dyes, tetrazolium dyes, thiazole dyes, perylene dyes, perinone dyes, bis-benzoxazolylthiophene (BBOT), xanthene dyes (e.g., thioxanthene dyes), indigoid dyes (e.g., thioindigoid dyes), chromones dyes, flavones dyes, or the like, or a combination thereof); semiconductor nanoparticles (e.g., quantum dots may be a Group I, a Group II, a Group III, a Group IV, a Group V, a Group VI quantum dot, a Group II-VI compound, a Group III-V compound, a Group IV-VI compound, a Group IV compound, a Group compound, a Group I-II-IV-VI compound or a combination thereof); transition metal complexes; materials with band gaps in the visible regime of the electromagnetic spectrum (e.g., cadmium sulfide (CdS); metal nanoparticles (e.g., Au, Ag, Pd, Pt, or the like), or a combination thereof. A preferred light absorbing particle includes carbon black particles or gold nanoparticles.

The light absorbing particles can be nanoparticles (having a particle size of 2 to 100 nanometers) or microparticles (having a particle size of 100.1 to 100,000 nanometers). The particles can have a unimodal or multimodal particle size distribution. Multimodal particle size distributions may include binodal, trinodal or multinodal particle size distributions. The light absorbing particles are generally present in the film in an amount of 5 to 65 weight percent (wt %), based on a total weight of the film. In a preferred embodiment, the light absorbing particles are generally present in the film in an amount of 10 to 40 weight percent (wt %), based on a total weight of the film. der4

The thickness of the film 106 is 20 to 200 micrometers, preferably 30 to 100 micrometers, and more preferably 40 to 80 micrometers.

### The Receiver

The receiver for the sensor comprises an optical waveguide having a distal end and a proximal end. A diaphragm is disposed apart from the distal end of the optical waveguide. A cavity located between the distal end of the optical waveguide and the diaphragm functions as a Fabry-Perot cavity. The proximal end of the optical waveguide is in optical communication with a photodiode, an avalanche photodiode, a phototransistor, or a combination thereof.

The receiver is generally disposed at one end of the optical waveguide and can receive reflected acoustic waves that are originally generated by the films (in the emitter). The receiver can comprise several different configurations. In a first configuration, the receiver comprises a diaphragm located opposite an end of the optical waveguide. The diaphragm is configured and arranged to convert acoustic energy to light energy into the receiver waveguide. In a second configuration, the tip is formed by a waveguide, cavity and a diaphragm or cantilever with or without a sphere. In a third configuration, the waveguide is tapered or a D-shape waveguide with a diaphragm/cantilever and a sphere attached to it.

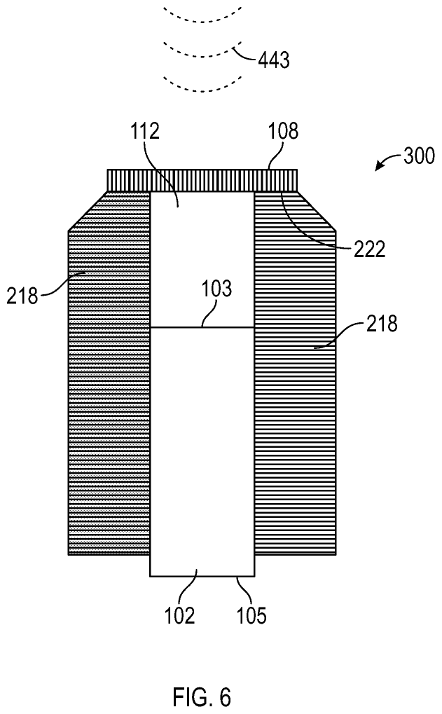

FIG. 6 depicts a receiver 300 that comprises a diaphragm 108 that is in operative communication with an optical waveguide 102 via a Fabry Perot cavity 112.

The diaphragm 108 lies opposite the distal end 103 of the optical waveguide 102. The diaphragm is located at a first end of the Fabry Perot cavity 112, while the distal end 103 of the optical waveguide 102 forms the opposing end of the cavity 112. The cavity 112 is enclosed on its sides by a sleeve 218. The sleeve 218 surrounds the optical waveguide 102 and provides a surface 222 that the diaphragm 108 contacts. The proximal end 105 of the optical waveguide 102 is in communication with a device (not shown) that measures the optical interference between the reflections of the diaphragm 108 and the waveguide 103—air cavity boundary. The interference is then used to track the desired property (e.g., temperature, pressure, density, and the like) as output reading. In an embodiment, the device located at the proximal end of the optical waveguide is a photodiode, an avalanche photodiode, a phototransistor, optical spectrum analyzer or a combination thereof. The photodiode, avalanche photodiode, phototransistor, or the like may be in contact with the appropriate amplifiers and other electronics including but not limited to a digital display.

The waveguide 102 may be a single mode waveguide, a multimode waveguide, or a photonic crystal waveguide. The waveguide 102 (also known as acousto-optic waveguide or photoelastic waveguide) is preferably a single mode waveguide that utilizes acousto-optic effects to manipulate light. These waveguide s are designed to support only a single mode of light propagation, meaning that only one specific optical mode can be guided through the waveguide. The primary mechanism that allows for this manipulation is the interaction between acoustic waves and the guided optical mode. Acoustic single mode waveguides are designed as a core of a specific size and refractive index profile to ensure the guidance of a single optical mode. The core may be surrounded by cladding (not shown in FIG. 6).

The single mode waveguide 102 generally comprises a specific type of glass selected for its photoelastic properties. Fused silica or other types of glasses with low optical attenuation and suitable photoelastic effects are often used. Some acoustic single mode waveguide s may use polymer materials for the core. Polymers can exhibit photoelasticity and are more flexible than glass, making them suitable for certain applications. The choice of polymer depends on the desired acoustic and optical properties.

As noted above, the single mode waveguide 102 typically has a cladding material (not shown in FIG. 6) disposed on its outer circumferential surface. The cladding material surrounding the core in acoustic single-mode waveguides is generally similar to that used in conventional single-mode waveguides. It is typically made of materials like silica glass or polyacrylates with a slightly different refractive index to create the necessary conditions for guiding the optical mode.

The diaphragm 108 can be manufactured from an elastomer, a polymer (that is not elastomeric at room temperature), or a ceramic. The elastomers are listed above and will not be detailed herein again. The ceramic may include a metal oxide, a metal carbide, a metal oxycarbide, a metal nitride, a metal oxynitride, a metal boride, a metal borocarbide, a metal boronitride, a metal silicide or a metal borosilicide.

Examples of polymers that (are not elastomers at room temperature) include thermoplastic polymers, thermosetting polymers, or a combination thereof. Examples of thermoplastic polymers include polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfonamides, polyureas, polyphosphazenes, polysilazanes, polypropylenes, polyethylenes, polyethylene terephthalates, polyvinylidene fluorides, or a combination thereof.

Examples of thermosetting polymers include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or a combination thereof.

A referred material for constructing the diaphragm is an elastomer such as polydimethylsiloxane. The diaphragm 108 generally has a thickness of 2 to 20 micrometers, 5 to 15 micrometers.

The sleeve 218 is manufactured via additive manufacturing (also called 3D manufacturing) or other manufacturing methods. This type of receiver is constructed using ferrules, which restrict the ability to design receivers with specific dimensions and or shapes. With a 3D printing process, the design can be tailored to specific designs as a result of which the manufacturing process is faster. In an embodiment, the inner surface of the sleeve 218 contacts an outer circumferential surface of the optical waveguide 102. The sleeve comprises a liquid photopolymer termed Clear resin RS-F2-GPCL-04 commercially available from Formlabs.

The Fabry Perot cavity 112 includes the gap between the sleeve 218, the distal end 103 of the single mode waveguide 102 and the surface of diaphragm 108 that faces the distal end 103. Acoustic waves in the media surrounding the receiver cause a vibration of the diaphragm. This vibration causes a change in the length of the cavity 112, which results in a spectrum range variation. By monitoring the spectrum shift in the reflected light in waveguide 102, the ultrasound signal can be collected.

In other words, acoustic waves impact the diaphragm 108. The acoustic waves will compress diaphragm 108 changing the space of the air cavity 103. When the laser light from the waveguide 102 hits the diaphragm, light is reflected back to the waveguide 102. An interference pattern will be created due to the interaction between the light reflected from the diaphragm 108 and from the distal end 103. The acoustic waves create periodic variations in the diaphragm affecting the cavity length 112. This modulation of the of the diaphragm provides data about the acoustic signal that is collected at the diaphragm 108.

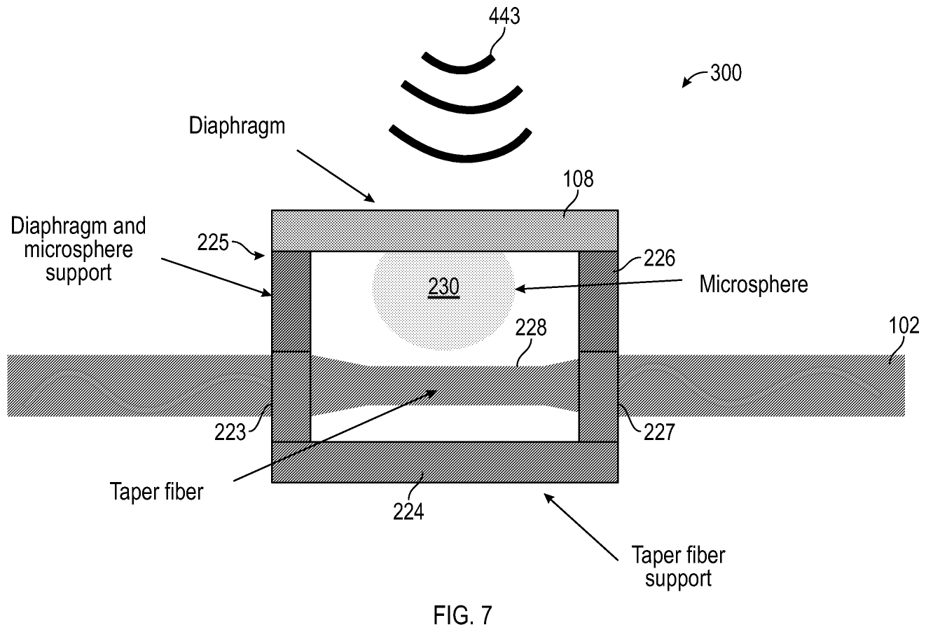

The acoustic receiver 300 may also be operated in a whispering gallery mode (WGD). FIG. 7 depicts another embodiment of an exemplary receiver 300 that comprises an opaque chamber 225 that includes a diaphragm 108 disposed on a container-like holding portion that comprises an upper section 226 and a lower section 224. The lower section 224 includes an inlet port 221 for receiving an optical waveguide 102 and an outlet port 227 for the optical waveguide to exit the chamber 225.

The portion of the optical waveguide 102 contained within the chamber 225 is tapered—i.e., it has a narrower diameter section 228 in its central portion situated within the chamber 225. A droplet 230 (hereinafter called a microsphere 230) is centrally located on the diaphragm 108 directly above the narrower diameter section 228 of the optical waveguide 102.

The receiver 300 of the FIG. 7 is manufactured as follows. First the optical waveguide is tapered down (i.e., a portion of it has a reduced diameter as compared with other portions of the optical waveguide). In this process, the cladding of an optical waveguide is first removed and then it is heated up using a flame torch with temperature between 1400-1700° C. As a torch is heating the waveguide, both ends of the waveguide are drawn away from each other continuously at a constant speed. The narrowed diameter of the tapered waveguide is less than 3 μm in order to generate a sufficient evanescent wave to couple with the microsphere. An evanescent wave is a phenomenon in wave optics that occurs near the boundary of two different media when a wave undergoes total internal reflection. This wave extends into the medium with the lower refractive index and decays exponentially with distance from the interface.

Once the tapered optical waveguide is fabricated, it is placed into the opaque chamber 225. The packaging is fabricated using an SLA 3D printer. Epoxy is used to attach the waveguide to the chamber 225 at the inlet port and the exit port.

SLA 3D printing is a type of 3D printing that uses stereolithography technology for additive manufacturing. The 3D printing process begins with a liquid photopolymer resin, which is typically stored in a vat beneath the build platform. The build platform is lowered into the liquid resin, and a UV laser or projector selectively exposes the resin to create the first layer of the object. Wherever the UV light contacts the resin, it solidifies, while the unexposed resin remains in liquid form. After the first layer is solidified, the build platform is slightly raised, and the next layer is exposed to UV light. This process is repeated layer by layer until the entire 3D object (the chamber 225) is formed. Once the printing is complete, the object is typically submerged in a solvent to remove any uncured resin. After rinsing, the object may undergo post-curing, often through exposure to additional UV light, to ensure the final part achieves its desired mechanical properties.

With reference now again to the FIG. 7, to detect ultrasound waves, a diaphragm 108 needs to be created to transfer the ultrasound signal into the microsphere 230. The diaphragm can be created using PDMS, silicon, rubber, ceramic, and elastic polymers. The diaphragm may be manufactured by injection molding or compression molding. A thin layer (of 10 μm thickness) is created, and the microsphere is attached to it. The diaphragm may have a thickness of 2 to 30 micrometers, preferably 5 to 25 micrometers, and more preferably 7 to 15 micrometers.

The microsphere can be created using a splicing process or employing a CO₂ laser. Creating a microsphere using a splicing process or a CO₂ laser involves precision engineering and controlled heating to shape and manipulate a glass waveguide into a spherical structure. A glass waveguide with a core and cladding structure (coating removed) is heated using either a CO₂ laser or the heating discharge from the waveguide splicer machine. A CO₂ laser system, which emits infrared light at a suitable wavelength is pointed to the tip of the waveguide and is used for heating the glass (of the optical waveguide). The localized heating softens the glass in that region and due to the surface tension, a microbubble (referred to as a microsphere) is formed. A similar procedure is adopted using the waveguide splicer, where the waveguide electrodes are placed at the waveguide tip. When a discharge happens, the waveguide is heated to temperatures that allows the glass to be soften. The surface tension will then form the sphere. The microsphere will be allowed to cool and solidify. The microsphere thus comprises the same composition as the optical waveguide core. By controlling the laser power and the exposure time of the waveguide tip to the high temperatures a different size of microsphere can be fabricated.

The cooling process may involve controlled annealing to relieve stress and ensure the microspheres stability.

In an exemplary embodiment, the microsphere has a diameter of 150 to 200 micrometers, but different sizes can be used as well. To attach the microsphere, it is placed in the center of the diaphragm 108 before the diaphragm is completely cured.

For ceramic or silica diaphragms, UV epoxy glues are used to create a bond between the microsphere and the diaphragm. The diaphragm and microsphere are then connected to the chamber that can be fabricated using 3D printing or etching process. The height of the chamber is adjusted based on the total dimension of the film and the sphere.

The microsphere and tapered waveguide are then integrated using UV epoxy glue. The top portion of the chamber 225 (the diaphragm and the microsphere) is aligned with the bottom (tapered) section with a distance between microspheres and waist section of less 1.5 micrometers.

With regard now again to the FIG. 7, when an acoustic wave 443 reaches the diaphragm 100, it promotes vibration in the diaphragm and the microsphere 230. This acoustic vibration interacts with the diaphragm changing the distance between the microsphere and the end 103 of the narrowed optical waveguide 102. The acoustic waves create periodic vibration in the diaphragm moving the microsphere closer or further from the waveguide tapered region. This periodic modulation causes an evanescence field to couple with the microsphere at different proportions. By examining the optical transmission signal, acoustic information can be extracted. Three methods can be implemented: (1) a wavelength shift which comprises tracking the displacement of the resonance wavelength; (2) mode-broadening which monitors changes in the transmission spectrum; and (3) mode-splitting which occurs due to the interplay between the two counter-propagating waves.

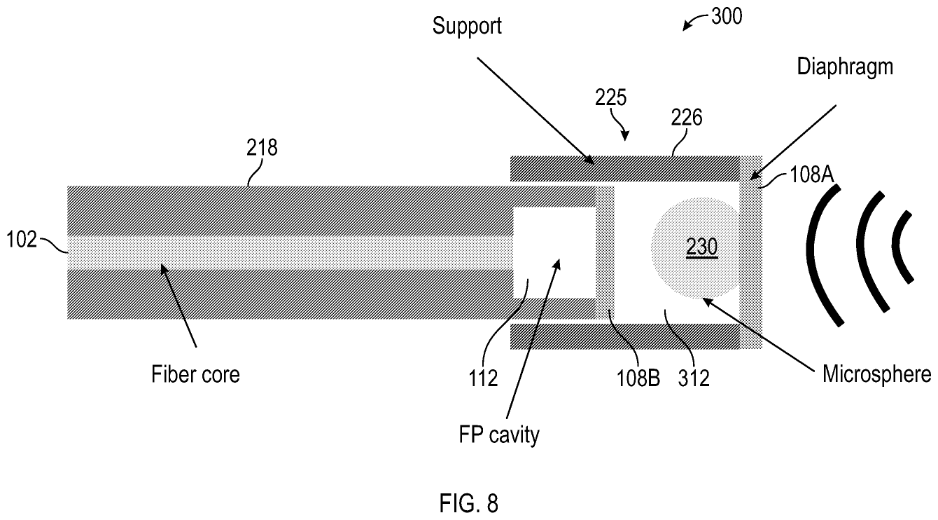

With reference now to FIG. 8 a third type of receiver 300 comprises two diaphragms 108A and 108B. The first diaphragm 108A is in contact with the microsphere 230 as has been detailed above. The manufacturing of the first diaphragm and the microsphere 230 has been explained above and will not be detailed again in the interests of brevity. The diaphragm 108A and the microsphere 230 are enclosed in an opaque chamber 225 that comprises walls 226 that prevent ambient light or external acoustic energy from interfering with the light and acoustic waves contained in the first enclosure 312. Located within this first enclosure is the Fabry Perot cavity 112 that is disposed between the second diaphragm 108B and the distal end 103 of the optical waveguide 102. The optical waveguide 102 is in contained in a sleeve 218. The sleeve 218 and the opaque chamber 225 may be manufactured using 3D manufacturing as detailed above.

When an acoustic wave 443 impinges on the first diaphragm 108A and the microsphere 230, it sets up a vibration in the first cavity 312. This acoustic vibration induces a second acoustic vibration in the Fabry Perot cavity 112, which modulates the standing wave in the optical waveguide. As detailed above, the modulation of the standing wave by the acoustic signal in the Fabry Perot cavity is used to estimate a measured property of the medium from which the acoustic wave was generated.

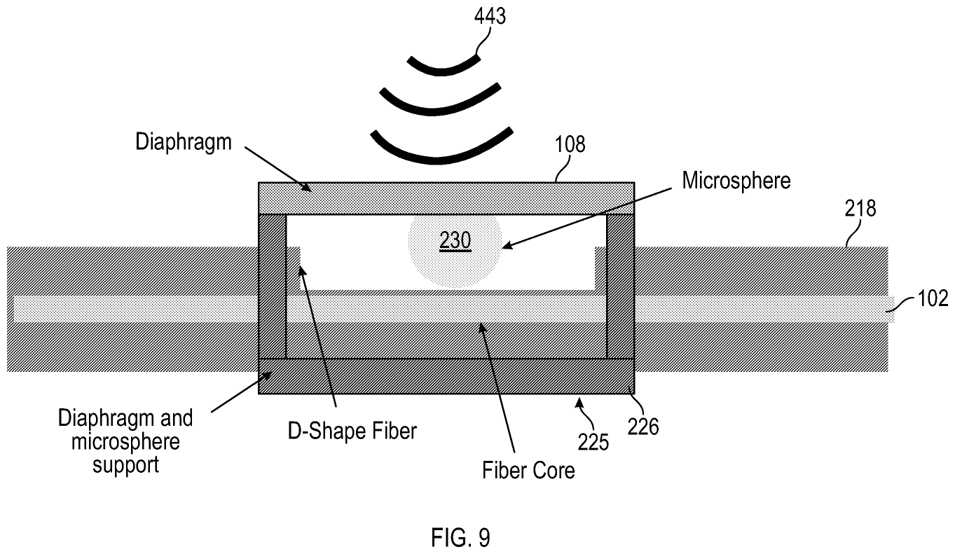

FIG. 9 depicts yet another embodiment of a receiver 300. The embodiment depicted in the FIG. 9 is termed a “D section receiver” because of the shape of the sleeve 218, which resembles the letter “D”. In this process, a portion of the waveguide sleeve D is first removed. The D-shaped section can be created using etching where a strong acid (e.g., hydrofluoric acid) is applied to the uncoated section of the waveguide. By knowing the etching rate, the cladding removal depth can be controlled, until it reaches the waveguide core region.

Another manner removing the cladding can be accomplished using a polishing machine. The section of the waveguide 102 is placed horizontally against the polishing film. Gently the waveguide 102 is pressed against the polisher film as it rotates. This process will sand down the cladding until the desired depth is achieved.

In order to detect ultrasound waves, a diaphragm 108 needs to be created to transfer the ultrasound signal into the microsphere 230. The diaphragm and the microsphere can be manufactured from the same materials (and in the same manner) listed in the descriptions associated with the FIGS. 7 and 8. They are bonded together in the same manner as detailed in the description associated with the FIGS. 7 and 8. These respective descriptions will not be repeated in the interests of brevity.

The diaphragm and microsphere are then connected to the opaque chamber 225 that can be fabricated using 3D printing or etching process. The walls 226 of the chamber 225 are adjusted to provide the right height based on the total dimension of the film and the sphere. In general, it is desirable for the microsphere 230 to be separated from the waveguide 103 by a distance of 1 to 5 millimeters, preferably 1.25 to 3 millimeters. The geometric center of the microsphere 230 is aligned with the center of the length of exposed waveguide 102 in the chamber 225. The waveguide 102 may be bonded to the chamber 225 using an adhesive. The adhesion prevents unnecessary movement of the waveguide with respect to the microsphere, which in turn minimizes distorted measurements. Epoxies are commonly used as adhesives.

When an incoming acoustic wave 443 impinges on the diaphragm, it promotes vibration in the microsphere. This acoustic vibration in the microsphere modulates the evanescent wave coupling to the microsphere created in the D-sections of the single mode waveguide 102. The extent of modulation of the standing wave in the waveguide by the acoustic wave provides a measure of a property of the medium from where the incoming acoustic wave 443 was generated.

### Combined Emitter and Receiver

A sensor can also comprise an emitter and a receiver. The emitter comprises a source of visible light, a first optical waveguide in optical communication with the source of light; and an optical absorption film in optical communication with the first optical waveguide. The optical absorption film has a different coefficient of thermal expansion from the first optical waveguide. The optical absorption film contacts a) a circumferential core surface of the first optical waveguide at one or more locations; b) a distal end of the first optical waveguide and is located downstream of the optical waveguide; or c) is located on the circumferential core surface of the first optical waveguide and downstream of the first optical waveguide at the distal end of the first optical waveguide.

The receiver comprises a second optical waveguide having a distal end and a proximal end with a diaphragm disposed apart from the distal end of the second optical waveguide. A cavity located between the distal end and the diaphragm functions as a Fabry-Perot cavity. The proximal end of the second optical waveguide is in optical communication with a photodiode, an avalanche photodiode, a phototransistor, or a combination thereof. In an embodiment, the first optical waveguide circumscribes the second optical waveguide. The second optical waveguide may be a single mode optical waveguide.

Disclosed herein too is a method of using a sensor to determine properties of the media that it is included in. The method comprises disposing a sensor in a vessel that contains a media. In one embodiment, the sensor can comprise an emitter and a receiver that are separate from each other and where both are disposed in the media. In another embodiment, the sensor comprises an emitter and a receiver that are part of a single device (as depicted and described below).

The method comprises transmitting an incident light signal from a visible source of light to an emitter via a first optical waveguide and promoting an acoustic vibration in the emitter in response to light absorbed from the incident light signal. The acoustic vibration is in the ultrasonic regime and is emitted into a vessel that contains media that is to be studied. The properties of the media are to be determined.

A receiver is introduced into the vessel. The receiver comprises a Fabry Perot cavity in optical communication with a second optical waveguide. A reflected acoustic signal from the media is received in response to the incident light signal (and the incident acoustic wave) A standing acoustic wave is created in a Fabry Perot cavity.

An optical standing wave in the second optical waveguide is modulated with the standing acoustic wave. The standing acoustic wave induces a periodic modulation in a refractive index of the second optical waveguide. The periodic modulation in the refractive index of the optical waveguide can be used to determine a property of the media.

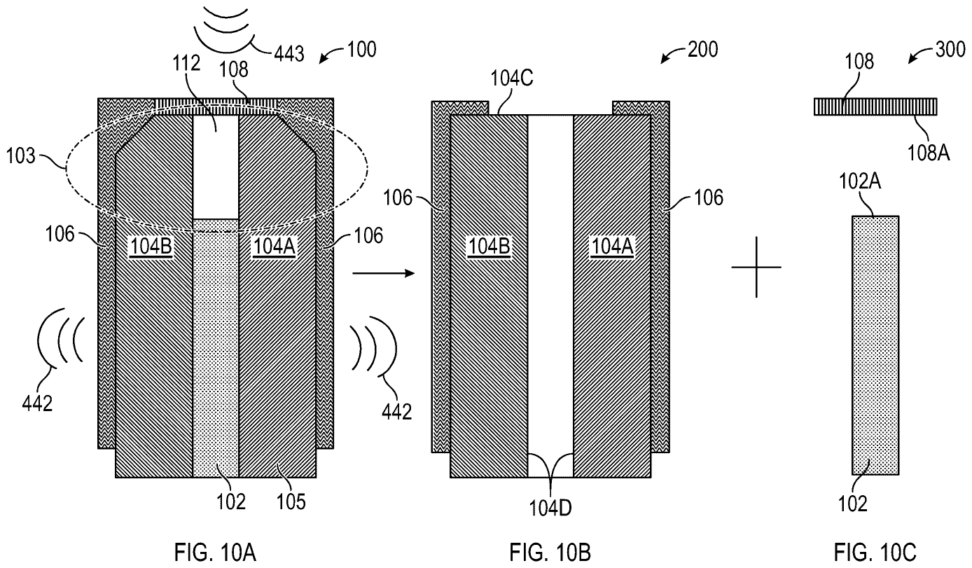

FIG. 10A depicts a side view of an exemplary embodiment of a composite sensor 100 that comprises an emitter 200 (FIG. 10B) and a receiver 300 (FIG. 10C). FIG. 10A depicts an exemplary view of the combined emitter 200 and receiver 300, while FIG. 10B depicts only the emitter 200 and FIG. 10C depicts only the receiver 300. The components of FIG. 10B and FIG. 10C may be combined to produce the sensor 100 depicted in the FIG. 10A.

With reference now to FIGS. 10A, 10B and 10C, the emitter 200 comprises one or more multimode waveguides 104A and/or 104B (also referred to as the first optical waveguide) surrounded by and in contact with an optical film 106 having light absorbing particles disposed therein, while the receiver 200 comprises a single mode waveguide 102 (also referred to as the second optical waveguide), a diaphragm 108 with a space 112 (the Fabry Perot cavity 112) disposed therebetween. The multimode waveguides 104A and/or 104B are tapered at the distal end and are surrounded by the optical film 106. The diaphragm is located opposite an end 102A of the single mode waveguide 102 and the space 112. The space 112 is bounded by the end 102A of the single mode waveguide, the inner circumferential surface 104D of the multimode waveguide s 104A and 104B and the surface 108A of the diaphragm 108. The space 112 constitutes the Fabry Perot cavity.

In an embodiment, the diaphragm 108 is disposed and supported on an end 104C of the multimode waveguides. The multimode waveguides 104A and 104B extend beyond the single mode waveguide 102. The single mode waveguide 102 and the multimode waveguides 104 have a proximal portion 105 and a distal portion 103. The distal portion 103 has the sensor 100 disposed on it, while the proximal portion may be in contact with a measuring device (not shown) that is operative to measure acoustically modulated light signals received from the waveguide s 104A and 104B. The measuring device may be calibrated to determine temperature, stress, strain, acoustic signals, and the like. The measuring device may be in communication with a microprocessor which can store readings.

While the film 106 is depicted as being located at the distal end 103 and disposed around the circumferential surface of the multimode waveguide in the FIGS. 10A, 10B and 10C, this may not always be the case. In an embodiment, the film 106 may be located on a portion of the multimode waveguides 104A and 104B further away from the distal end (See FIGS. 2 and 3B) or alternatively, may be located at the distal end but not in direct contact with the circumferential surface of the multimode waveguide(s) (see FIGS. 4A-4C).

The film 106 comprises a material that can undergo a dimensional change upon the absorption of visible light. The absorption of visible light from the optical waveguide causes the film 106 to heat and undergo vibrations that produce acoustic waves (pressure waves). These outgoing acoustic waves 442 are transmitted into a medium whose properties are desired. The desired properties that can be measured include temperature, pressure, strain, stress, cavitation, density, and so on. Reflected acoustic waves 443 are received by the diaphragm 108. These reflected acoustic waves 443 form a standing wave in the acoustic Fabry Perot cavity 112 or in the diaphragm. The standing acoustic wave formed in the cavity or diaphragm changes the cavity space modulating the standing wave formed in the optical waveguide 102. This modulation provides a measure of the properties of the media into which the sensor is introduced. The modulation of the standing wave in the single mode waveguide 102 is measured by a device such as a transducer (not shown). Readings from the transducer can be fed into a microprocessor (not shown) for comparison or purely for recording purposes.

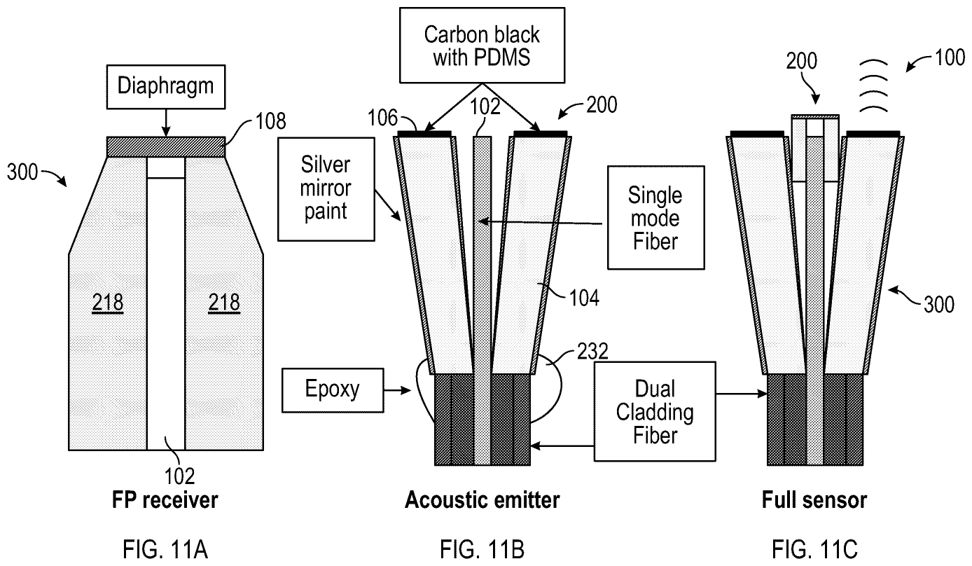

FIGS. 11A-11C depicts another embodiment of a sensor 100 (see FIG. 11C) that combines the receiver 300 (FIG. 11A) with the emitter 200 (FIG. 11B). The receiver depicted in the FIG. 11A is similar to that detailed in the FIG. 6 and will not be elaborated upon again. The FIG. 11B depicts the emitter 300 that comprises an optical waveguide 104. The optical waveguide 104 has disposed on its distal end the film 106, which as noted above comprises an elastomer and an optical absorbing filler. The optical waveguide 104 may be a single mode waveguide or a multimode optical waveguide. In a preferred embodiment, the optical waveguide 104 may be a hollow multimode optical waveguide. The single mode waveguide 102 that is a part of the receiver 200 may be disposed on an inner surface of the hollow multimode optical waveguide. In another embodiment, the optical waveguide 104 may comprise two multimode optical waveguide s 104A and 104B as depicted in the FIGS. 10A and 10B.

The film 106 heats upon absorbing light from the optical waveguide 104 leading to the generation of acoustic waves 442. The acoustic waves are transmitted into the media that the sensor 100 is disposed in. Acoustic waves reflected from the medium are collected at the receiver 300 as detailed above in the FIG. 6. The acoustic waves modulate the standing wave (as detailed above) in the optical waveguide 102 to provide a reading of the various properties of the media into which the sensor is disposed.

### Theoretical Considerations

The photoacoustic imaging (PAI) technique was derived from the material characteristics of optical absorption. Thus, the light energy will transform into thermal energy. The heat will facilitate transient thermoelastic characteristics of the medium (the film 106) and result in ultrasound emission. Three conditions must be satisfied to generate a photoacoustic signal. First, the testing target (the film 106) should have an excellent ability to absorb light. Secondly, the film should have a thermal sensitivity expansion. Thirdly, thermoelastic expansion should take place in the medium or the surface.

To generate acoustic waves, modulated light sources or pulsed lasers are introduced to achieve time-variant displacement. Pulsed lasers are widely used as the light source in PAI for the advantages of small divergence, high energy, and controllable periods. To generate PA waves, two important time scales are necessary. The first one is the thermal relaxation time (τₜₕ) and the second one is the relaxation time (τₛ). The thermal relaxation, also known as thermal diffusion, is given by:

$${τ}_{th} = \frac{{d}_{c}^{2}}{{α}_{th}}$$

where d_{c} is the desired spatial resolution and αₜₕ is the thermal diffusivity (m²/s). The relaxation time τₛ is given by:

$${τ}_{s} = \frac{{d}_{C}}{{α}_{s}}$$

where νₛ is the speed of sound (m/s).

Under the short pulse excitation condition, the fractional expansion in the target can be expressed as,

$$\frac{dV}{V} = - κ p ( r ) + β T ( r )$$

where κ is defined as the isothermal compressibility (Pa⁻¹), β is the thermal coefficient of expansion (K⁻¹)T(r) (K) and p(r) are the temperature and pressure changes, respectively. The pulsed laser generates the photoacoustic signal, typically having a very short pulse duration in the nanosecond range. If laser pulse duration is shorted than the thermal and stress relaxation time, the excitation satisfies both thermal and stress conferment. In this case, the fractional volume change is negligible. Thus, the initial pressure can be derived from:

$${p}_{o} = \frac{β T}{κ}$$

The local temperature change is expressed as:

$$T = \frac{{η}_{th} {A}_{e}}{ρ {C}_{v}}$$

where ηₜₕ is the percentage of absorbed light converted into heat, and Aₑ is the specific optical energy deposition (J/m³). Combining the last two equations above:

$${p}_{o} = \frac{β}{κ ρ {C}_{v}} {η}_{th} {A}_{e}$$

By defining the Grüneisen parameter Γ as:

$$Γ = \frac{β}{κ ρ {C}_{v}}$$

The initial pressure equation becomes:

$${p}_{o} = Γ {η}_{th} {A}_{e}$$

Where Aₑ is proportional to the local optical fluence F, and μₐ the optical absortin coefficient (cm⁻¹)

$${p}_{o} = Γ {η}_{th} {μ}_{a} F$$

After the initial pressure is generated, the acoustic wave starts propagating at the speed of sound in the specific material.

The sensors along with the materials contained therein as well as the methods of manufacturing thereof are exemplified by the following non-limiting examples.

### EXAMPLES

### Example 1

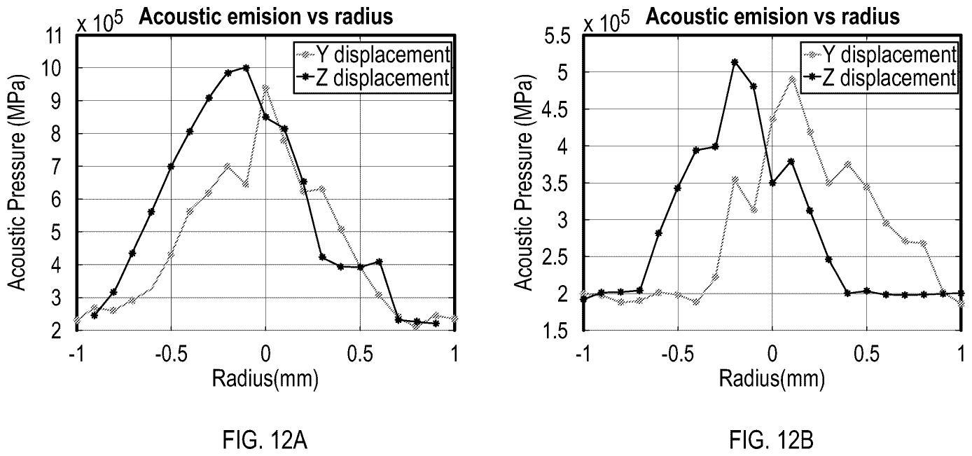

This example was conducted to demonstrate whether a resin used in the 3D manufacturing process printer is capable of transmitting a 1064 nm pulse laser. The resin used is Clear Resin RS-F2-GPCL-04 obtained from Formlabs. A cylinder was printed using the 3D printer and coated with carbon black mixed with polydimethylsiloxane (PDMS). After the material was printed, acoustic emission was measured using a hydrophone. The graph in FIGS. 12A and 12B which measures acoustic pressure (MPa) versus radius demonstrate the capability of the resin to be used as an acoustic emitter. As the hydrophone is moved further away from the center of the part, the acoustic pressure decreases in value.

### Example 2

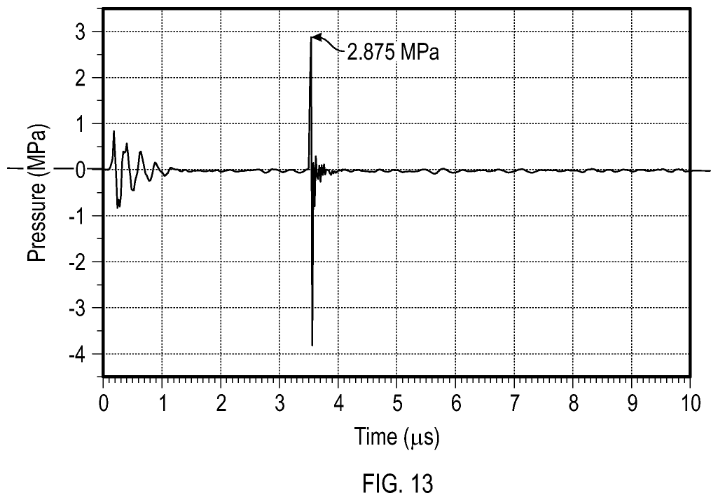

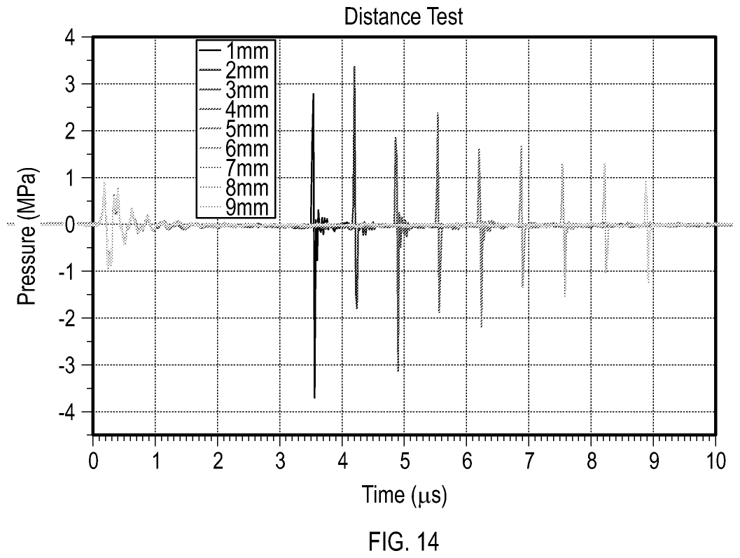

This example was conducted to demonstrate the manufacture and use of an emitter located at the distal end of the optical fiber. A 1500 μm diameter multimode fiber (from OFS) was used to fabricate a photoacoustic fiber tip emitter. The optically absorbing film contains PDMS and carbon black. The carbon black is present in an amount of 10 wt %, based on a total weight of the film. The ratio of the PDMS resin to the crosslinking agent (used to crosslink the PDMS) is 7:3. The fiber tip is coated by a dip coating process. As shown in FIG. 13, the photoacoustic signal was collected by a hydrophone. The fiber tip emitter generated a 2.875 MPa signal at 3.58 μs. FIG. 13 is a graph of pressure versus time in microseconds for the 1500 μm fiber tip. As the hydrophone was moved away from the fiber tip, the power of the generated photoacoustic signal is decreased. The distance between each test was 1 mm and can be expressed as 0.676 μs in FIG. 14. FIG. 14 is a graph of pressure versus time in microseconds as the hydrophone is moved away from the 1500 μm fiber tip.

### Example 3

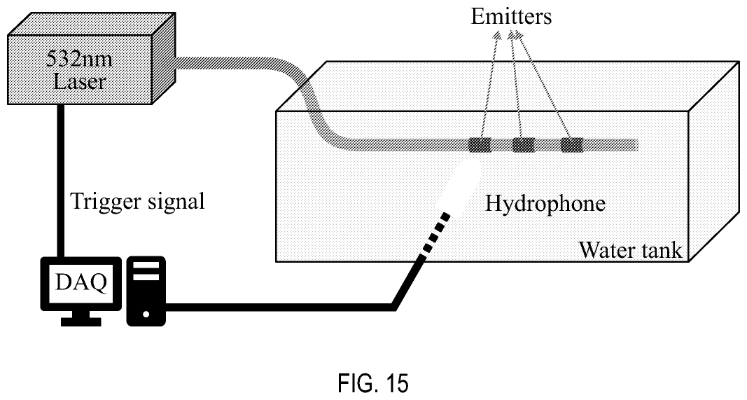

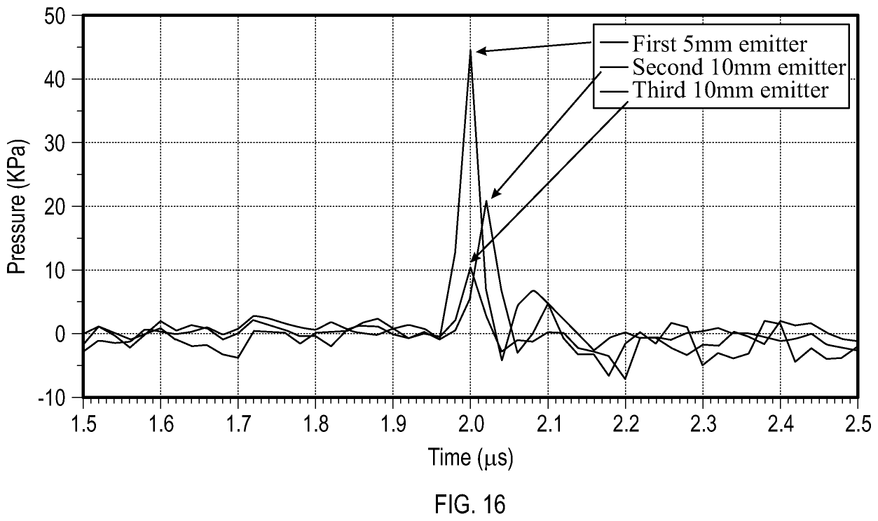

This example was conducted to demonstrate the simultaneous use of an emitter as well as the receiver in a water tank. FIG. 15 shows a schematic of the experiment setup. The laser source we used was a 532 nm nanosecond laser (Surelite I-10, Continuum), and the probe was aligned with the laser and fixed in a water tank for testing. A hydrophone (HGL-0200, Onda) was used to detect and record the ultrasound signal, and the data was collected by a DAQ system (M2i.4032, Spectrum). The hydrophone was placed in a linear stage and can be controlled by moving between each emitter using two-axis step motors. (NRT150/M, Thorlab; NRT100/M, Thorlab). The ultrasound signal was detected from each emitter, 44.34 KPa, 21.04 KPa, and 10.46 KPa respectively as seen in FIG. 16.

### Example 4

This example was conducted to demonstrate the coating of the film on a circumferential surface of the optical fiber. A 1500 μm high-power delivery multimode fiber (MMF) was utilized in the fabrication of the photonic amplifier (PA) emitter. The buffer and cladding layers of the MMF were removed using a flame torch. Subsequently, a glass etching cream was applied to the fiber core to reduce its diameter, thereby enhancing light leakage from the fiber core to the film which is disposed on the circumferential surface of the optical fiber. From photomicrographs (not shown here), it may be seen that the optical fiber core diameter is 1458 μm, with the PDMS and carbon black film having a thickness of 58.5 μm.

The emitters and/or receivers detailed above may be used in sensors that for detecting pressure changes, temperature changes, a refractive index changes, a gas composition sensor, and so on. These designs not only provides for multiple parameter measurements at various locations, but the ability to generate and collect multiple forms of data by such sensors can be used to better understand complex scenarios encountered in life. For example, the combination of various forms of emitters and receivers can be used to detect and localize gas leaks in a pipeline. The optimal design of the combination of a temperature sensor, a strain sensor, a shape sensor, a refractive index sensors can be useful for biomedical applications.

While the invention has been described with reference to some embodiments, it will be understood by those skilled in the art that various changes may be made, and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An emitter for a sensor, the emitter comprising:
a source of visible light;
an optical waveguide in optical communication with the source of light; and
an optical absorption film in optical communication with the optical waveguide; where the optical absorption film has a different coefficient of thermal expansion from the optical waveguide; where the optical absorption film contacts a) a circumferential core surface of the optical waveguide; b) does not physically contact the optical waveguide but is located downstream of the optical waveguide; or c) is located on the circumferential core surface of the optical waveguide and downstream of the optical waveguide.

2. The emitter of claim 1, wherein the optical absorption film comprises a light operating particle that is operative to absorb the visible light and an elastomer.

3. The emitter of claim 2, wherein the elastomer comprises polybutadienes, polyisoprenes, styrene-butadiene rubber, poly(styrene)-block-poly(butadiene), poly(acrylonitrile)-block-poly(styrene)-block-poly(butadiene), polychloroprenes, epichlorohydrin rubbers, polyacrylic rubbers, polysiloxanes, fluorosilicone elastomers, fluoroelastomers, perfluoroelastomers, polyether block amides, chlorosulfonated polyethylenes, ethylene propylene diene rubbers, ethylene-vinyl acetate elastomers, polyurethanes, or a combination thereof.

4. The emitter of claim 2, wherein the light absorbing particle comprises carbon black, carbon nanotubes, black iron oxide, organic dyes, transition metal complexes, metal particles, semiconductor particles, materials with band gaps in the visible regime of the electromagnetic spectrum, or a combination thereof; where the light absorbing particles are nanoparticles or microparticles.

5. The emitter of claim 2, where the light absorbing particle comprises carbon black and wherein the elastomer comprises a crosslinked polydimethylsiloxane.

6. The emitter of claim 1, where the optical absorption film is disposed on a tapered portion of the core of the optical waveguide; where the tapered portion has a reduced diameter when compared with a portion that is not tapered.

7. The emitter of claim 1, further comprising an opaque housing; where the opaque housing is in contact with the optical waveguide and the optical absorption film; where the housing facilitates locating the optical absorption film downstream of the optical waveguide.

8. The emitter of claim 7, where the opaque housing has a shape based on Euclidean geometry or has an irregular shape based on non-Euclidean geometry.

9. A receiver for a sensor, the receiver comprising:
an optical waveguide having a distal end and a proximal end; and
a diaphragm disposed apart from the distal end of the optical waveguide; where a cavity located between the distal end and the diaphragm functions as a Fabry-Perot cavity; where the proximal end of the optical waveguide is in optical communication with a photodiode, an avalanche photodiode, a phototransistor, or a combination thereof.

10. The receiver of claim 9, wherein an acoustic wave that impinges on the diaphragm facilitates a modulation of refractive index in the optical waveguide; and wherein the refractive index modulation is used to compute a property of a media that facilitates transmission of the acoustic wave to the diaphragm.

11. The receiver of claim 9, where the optical waveguide is a single mode optical waveguide.

12. The receiver of claim 9, further comprising a microsphere disposed a) proximate to a core circumference of the optical wire; b) opposite to a distal end of the optical waveguide; or c) proximate to the core circumference of the optical wire and opposite to the distal end of the optical waveguide.

13. The receiver of claim 12, where the diaphragm comprises an elastomer and wherein the microsphere comprises silica; and where the optical waveguide is tapered proximal to the microsphere.

14. (canceled)

15. A sensor comprising:
an emitter and a receiver;
where the emitter comprises:
a source of visible light;
a first optical waveguide in optical communication with the source of light; and
an optical absorption film in optical communication with the first optical waveguide;
where the optical absorption film has a different coefficient of thermal expansion from the first optical waveguide; where the optical absorption film contacts a) a circumferential core surface of the first optical waveguide; b) a distal end of the first optical waveguide and is located downstream of the optical waveguide; or c) is located on the circumferential core surface of the first optical waveguide and downstream of the first optical waveguide at the distal end of the first optical waveguide; and
where the receiver comprises:
a second optical waveguide having a distal end and a proximal end; and
a diaphragm disposed apart from the distal end of the second optical waveguide; where a cavity located between the distal end and the diaphragm functions as a Fabry-Perot cavity; where the proximal end of the second optical waveguide is in optical communication with a photodiode, an avalanche photodiode, a phototransistor, or a combination thereof; where the first optical waveguide circumscribes the second optical waveguide; where the second optical waveguide is a single mode optical waveguide.

16. The sensor of claim 15, wherein the optical absorption film comprises a light operating particle that is operative to absorb the visible light and an elastomer; where the light absorbing particle comprises carbon black and wherein the elastomer comprises a crosslinked polydimethylsiloxane.

17. The sensor of claim 15, where diaphragm comprises an elastomer and wherein an acoustic wave that impinges on the diaphragm facilitates a refractive index modulation in the optical waveguide; and wherein the refractive index modulation is used to compute a property of a media that transmits the acoustic wave to the diaphragm.

18. The emitter of claim 1, where the emitter is used to determine a change in pressure, refractive index, temperature, strain, stress, elasticity, or a combination thereof.

19. A method of determining a property of a media, the method comprising:
disposing a sensor in a vessel that contains a media; where the sensor comprises an emitter;
transmitting an incident light signal from a visible source of light to the emitter via a first optical waveguide;
promoting an acoustic vibration in the emitter in response to light absorbed from the incident light signal; where the acoustic vibration is in the ultrasonic regime;
disposing a receiver in the vessel; where the receiver comprises a Fabry Perot cavity in optical communication with a second optical waveguide;
receiving a reflected acoustic signal from the media in response to the incident light signal;
creating a standing acoustic wave in a Fabry Perot cavity;
modulating an optical standing wave in the second optical waveguide with the standing acoustic wave; where the standing acoustic wave induces a periodic modulation in a refractive index of the second optical waveguide; and
determining a property of the media, by the amount of modulation of the refractive index of the second optical waveguide.

20. The method of claim 19, where the emitter comprises:
the source of visible light;
the first optical waveguide in optical communication with the source of light; and
an optical absorption film in optical communication with the first optical waveguide; where the optical absorption film has a different coefficient of thermal expansion from the first optical waveguide; where the optical absorption film contacts a) a circumferential core surface of the first optical waveguide; b) does not physically contact the first optical waveguide but is located downstream of the first optical waveguide; or c) is located on the circumferential core surface of the first optical waveguide and downstream of the first optical waveguide, but not in physical contact with the first optical waveguide; and
where the receiver comprises:
the second optical waveguide having a distal end and a proximal end; and
a diaphragm disposed apart from the distal end of the second optical waveguide; where a cavity located between the distal end and the diaphragm functions as a Fabry-Perot cavity; where the proximal end of the second optical waveguide is in optical communication with a photodiode, an avalanche photodiode, a phototransistor, or a combination thereof.

21. The receiver of claim 9, where the receiver is used to determine a change in pressure, refractive index, temperature, strain, stress, elasticity, or a combination thereof.
